(19) United States
(12) Patent Application Publication
(10) Pub. No.: US 2015/0124325 A1
(43) Pub. Date: May 7, 2015

(54) ANTIREFLECTION GLAZING UNIT EQUIPPED WITH A POROUS COATING

(71) Applicants: Jean-Christophe Giron, Edina, MN (US); Christian Bernhard Petersen, Aachen (DE); Martin Melcher, Hertzogenrath (DE); Nicolas Nadaud, Paris (FR)

(72) Inventors: Jean-Christophe Giron, Edina, MN (US); Christian Bernhard Petersen, Aachen (DE); Martin Melcher, Hertzogenrath (DE); Nicolas Nadaud, Paris (FR)

(73) Assignee: SAINT-GOBAIN GLASS FRANCE, Courbevoie (FR)

(21) Appl. No.: 14/238,702

(22) PCT Filed: Aug. 6, 2012
(86) PCT No.: PCT/FR2012/051850

§ 371 Date: Apr. 22, 2014

(30) Foreign Application Priority Data
Aug. 18, 2011 (FR) 1157400

(51) Int. Cl. G02B 1/111; B05D 7/24; B05D 3/06

(52) U.S. Cl. CPC G02B 1/111; B05D 3/068; B05D 7/24
USPC 359/601; 428/195.1; 427/535

(57) ABSTRACT

A glazing unit including a transparent substrate equipped with an antireflection coating, which coating includes at least one film of a porous material essentially including silicon, oxygen, carbon and possibly hydrogen, in which the atomic proportion P_{C} of carbon, relative to the sum of the atomic contributions of silicon, oxygen and carbon, varies locally in the thickness direction of the film, from a first surface to a second surface thereof:
increasing between a first minimum value P_{Cmin1} and a maximum value P_{Cmax}, the ratio of the maximum value P_{Cmax} to the first minimum value P_{Cmin1} being at least 1.2; and
the proportion of carbon then decreasing, between the maximum value P_{Cmax} and a second minimum value P_{Cmin2}, the ratio of the maximum value P_{Cmax} to the second minimum value P_{Cmin2} being at least 1.2.

The invention relates to an antireflection coating applied to a glass substrate and to the glazing unit thus obtained, which glazing has a high energy transmission, especially in the wavelength range from 300 to 2500 nm.

Such a glazing unit may especially be applied in devices used to cover luminous solar energy, and especially in the field of photovoltaics or solar collectors.

It is well known that some of the light passing through a substrate, especially a glass substrate, is reflected at the surface of the latter, the amount of reflection being proportional to the angle of incidence of the light. Such reflection substantially decreases the efficiency of the photovoltaic systems or solar collectors protected by the substrate. In the architectural or automotive field, it is also sometimes desirable to decrease light reflection, for reasons of safety and/or for esthetical reasons, or even to improve the energy transmission coefficient and/or the solar factor SF.

The concept of depositing an antireflection coating on a transparent glass substrate is well known in the art: it involves depositing, on the substrate, of refractive index n=1.5, an interference film or film multilayer allowing the percentage of light reflected at the surface of the substrate to be decreased.

By adjusting the number, the chemical nature (and therefore the optical index) and the thicknesses of the various successive films of the multilayer, it is possible to reduce reflection to very low values, whether in the visible domain (350 to 800 nm) or in the near-infrared domain (800 to 2500 nm).

For example, the applicant company has already described, especially in application EP 1 206 715 A1, antireflection multilayers comprising low- and high-index films in succession, which multilayers allow antireflection glazing units to be obtained. The various thin interference films making up the multilayers are conventionally deposited using vacuum sputtering deposition techniques.

Regarding another technique, it has also been suggested, especially in patent EP 1 181 256 B1, to use antireflection coatings consisting of a single film of a material essentially made of porous silicon oxide. According to this prior art document, employing such a porous material, the thickness of the film of which is adjusted depending on the wavelength of the incident radiation, allows the refractive index to be decreased to values neighboring 1.22, and consequently to obtain an almost greatly smaller reflection at the surface of a glass substrate of index 1.5, this film keeping most of its porosity during a sinter at at least 630° C. The process used to synthesize such a film comprises an essential step of hydrolytically condensing a silicon compound of the general formula RSiX₄ via the sol-gel process.

Patent application EP 1 676 291 describes, again to obtain a porous silicon-oxide film of refractive index lower than that of the glass used as a substrate, processes comprising, in a first step, chemical vapor deposition (CVD) or physical vapor deposition (PVD) of a primary film of a material containing oxygen, silicon, carbon and hydrogen. In a second step, the primary film is subjected to a heat treatment (heating) allowing a porous film to be obtained by removal of at least some of the carbon and hydrogen present in the primary film, the porous film obtained having a nanoscale porosity.

Patent application EP 1 676 291 in particular describes one possible method, namely a PVD process that comprises sputtering a target made of silica or metallic silicon in a reactive atmosphere comprising a mixture of alkenes or an alkeneoxygen mixture in an argon or argonoxygen plasma gas. An additional source of silicon may be introduced into the plasma gas, in order to increase the speed with which the film is deposited on the substrate.

However, first of all such a production process causes problems with the ultimately obtained film: if a target made of pure silicon is used, trials have shown that it is impossible to obtain films having a low index relative to the refractive index of the nonporous material. When a porous material is said to have a “low” index, it is understood, in the present invention, to mean that the porosity of said material decreases said index by at least 5% or even 10% relative to the known index of the nonporous material. The terms “index” and “refractive index” are understood, in the present invention, to mean the refractive index measured at a wavelength of 550 nm.

In particular, whatever the target used (silicon oxide or metallic silicon), a necessarily large portion of the deposited material is dense silicon dioxide, which has a high refractive index (1.47). Therefore, it would appear to be impossible, using such manufacturing techniques, to obtain, ultimately, a film that is porous in its entirety and therefore the lowest theoretically possible refractive indices.

Furthermore, using a target made of silicon oxide causes problems because silicon oxide is not a conductor, it thus makes a very poor quality cathode, leading to electric arcing in the installation. Furthermore, using such targets in sputtering techniques requires radiofrequency biasing of the target, this biasing commonly results in deposits with a nonuniform thickness over the entire width of the glass substrate when the latter is more than 2 m wide.

In the case where a single film is deposited on a glass substrate, it is better to deposit materials that are easy or inexpensive to deposit, and that have a refractive index that is lower than that of the glass substrate, so as to limit reflection at the surface of the substrate. Alternatively, in the case of a film multilayer with an antireflection function, providing, in the multilayer, at least one porous film obtained according to the invention, and the refractive index of which can be adjusted, i.e. in particular the index of which may be several percent lower than that of the nonporous source material, offers additional degrees of freedom for adjusting the antireflection effect.

The present invention relates to a glazing unit comprising a substrate on which a porous coating based on silicon, oxygen and carbon is deposited, this coating having antireflection properties, especially allowing the energy transmission coefficient T_{E} for incident solar radiation, as described in ISO standard 9050:2003, to be increased, in particular in the wavelength range from 300-2500 nm, for photovoltaic applications.

Furthermore, if such durable coatings are to be used they must necessarily be durable over time, i.e. their initial optical qualities must not or not greatly deteriorate under climatic conditions, and must furthermore be able to effectively withstand the various handling and cleaning operations to which they are subjected.

Thus, according to another aspect of the present invention, a glazing unit is provided, this glazing unit being equipped with an antireflection coating the mechanical and chemical resistance of which is improved, especially as regards abrasion and hydrolytic reactions.

More precisely, the present invention relates, according to a first aspect, to a glazing unit comprising a transparent, especially glass, substrate equipped with an antireflection coating, which coating comprises at least one film of a porous material essentially comprising silicon, oxygen, carbon and possibly hydrogen, in which the atomic proportion P_{C} of carbon, relative to the sum of the atomic contributions of silicon (P_{Si}), oxygen (P_{O}) and carbon (P_{C}), varies locally in the thickness direction of the film, from a first surface to a second surface thereof:
increasing between a first minimum value P_{Cmin1} and a maximum value P_{Cmax}, the ratio of said maximum value P_{Cmax} to said first minimum value P_{Cmin1} being at least 1.2; and
the proportion of carbon then decreasing, between said maximum value P_{Cmax} and a second minimum value P_{Cmin2}, the ratio of said maximum value P_{Cmax} to said second minimum value P_{Cmin2} being at least 1.2.

According to preferred embodiments of the present invention:

said film has the following general chemical composition, in terms of the respective atomic proportions of just the constituent silicon, oxygen and carbon elements of the composition of the porous material from which said film is made:
between 28 and 38% silicon;
between 55 and 68% oxygen; and
between 2 and 10% carbon.

The expression “respective atomic proportion” (or relative atomic proportion), is understood to mean the proportion of each element C, O or Si relative to the total sum of the atomic contributions of just these three elements, averaged over the entire thickness of the film;
the antireflection coating consists only of the film of porous material, in which the minimum value P_{Cmin1} of the proportion of carbon in the porous film is reached at the air-side surface of said film or near said surface, and in which the minimum value P_{Cmin2} of the proportion of carbon in the porous film is reached at or near the surface of the substrate;
the respective proportion of silicon in the film is between 30 at % and 35 at %; the respective proportion of oxygen in the film is between 58 at % and 65 at %;
the respective proportion of carbon in the film is between 3 at % and 8 at %;
the overall amount of carbon in the material of the film is lower than 10 at %, preferably lower than 8 at % and even more preferably lower than 5 at %;
the ratios P_{Cmax}/P_{Cmin1} and/or P_{Cmax}/P_{Cmin2} are higher than 1.5 and preferably higher than 2;
the film comprises a succession of minimum values P_{Cmin} and maximum values P_{Cmax} of the respective proportion of carbon, in the thickness direction of the film;
the porous film is between 30 and 150 nm in thickness and preferably between 50 and 120 nm in thickness; and
the refractive index of the porous film is lower than 1.42 and preferably is lower than 1.40 or even lower than 1.35.

The invention also relates to the porous film such as described above, made of a porous material essentially comprising silicon, oxygen, carbon and possibly hydrogen, in which the atomic proportion P_{C} of carbon, relative to the sum of the atomic contributions of silicon, oxygen and carbon, varies locally in the thickness direction of the film, from a first surface to a second surface thereof:
increasing between a first minimum value P_{Cmin1} and a maximum value P_{Cmax}, the ratio of said maximum value P_{Cmax} to said first minimum value P_{Cmin1} being at least 1.2; and
the proportion of carbon then decreasing, between said maximum value Pₘₐₓ and a second minimum value P_{Cmin2f} the ratio of said maximum value Pₘₐₓ to said second minimum value P_{Cmin2} being at least 1.2.

The present invention furthermore relates to the process for manufacturing a glazing unit such as described above, comprising the following steps:
a plasma is generated at the surface of the substrate over its entire width by means of a device comprising at least two plasma beam sources each comprising a cavity in which a discharge is generated, a nozzle that extends toward the exterior, and a plurality of magnets placed facing one another and arranged adjacent the discharge cavity, such that a magnetic-field free region is created inside each discharge cavity, an oxygen-containing ionizable gas being introduced into each discharge cavity and each plasma beam source alternately serving as an anode or a cathode;
the substrate is run under the plasma beams;
at least one silicon precursor compound is deposited on said substrate between the two plasma sources;
the substrate equipped with a film of a material comprising silicon, oxygen, carbon, and possibly hydrogen, is recovered; and
the film thus deposited is subjected to a heat treatment under conditions allowing at least part of the carbon to be removed and said film of the porous material to be obtained.

Advantageously, in the manufacturing process according to the invention,
the ionizable gas is a mixture of argon and oxygen the total pressure of the gasses being between 1×10⁻³ and 1×10⁻² mbar; and
the one or more silicon precursors are chosen from silicon organometallics, and in particular chosen from siloxanes, for example hexamethyl disiloxane (HMDSO), or tetramethyl disiloxane (TDMSO), alkylsilanes, for example diethoxymethylsilane (DENS), Si(CH₃)₃)₂ (HMDS), Si(CH₃)₄ (TMS), (SiO(CH₃)₂)₄, (SiH(CH₃)₂)₂, silicon alcoholates, for example Si(OC₂H₅)₄ (TEOS), Si(OCH₃)₄ (TMOS), or even silicon hydrides, in particular SiH₄ or Si₂H₆, or silicon chlorides, in particular SiH₄, CH₃SiCl₃, (CH₃)₂SiCl₂, preferably from HDMSO or TDMSO.

In other possible embodiments according to the present invention:
additional gases, such as CH₄ or C₂H₂, are added, the role of which gases is to increase the amount of CH in the film before it is tempered. These gases may be injected at the same time as the Si precursor or separately in the chamber, but always near the plasma generated by the device;
depending on the type of coating desired, the precursor chosen either comprises a small amount of hydrogen, such as TDMSO, in order to obtain a film containing no or little hydrogen, or a larger amount of hydrogen, such as HDMSO, in order to obtain a hydrogen-containing primary film, i.e. a film of SiOₓC_{y}H_{z};
the heat treatment is carried out in air;
the heat treatment is carried out in a vacuum;
the heat treatment is a tempering or bending treatment;
the heat treatment is a treatment process such as described in application WO 2008096089, in which each point of the film is raised to a temperature of at least 300° C. while every point of the face of said substrate opposite said first face is kept at a temperature of 150° C. or less; and
the porous film is deposited on a first face of the substrate, in the same vacuum cavity or cavities used for magnetron deposition, on the other face of said substrate, of a thin-film multilayer having a low-E or antisolar functionality.

The invention and its advantages will be better understood on reading the follow example.

### EXAMPLE ACCORDING TO THE INVENTION

In this example according to the invention, a first coating film comprising silicon, carbon and oxygen was deposited using the device and concepts described in application U.S. Pat. No. 7,411,352, in particular from column 12 line 4 to column 14 line 7, and in relation to FIGS. 12A and 12B.

More precisely, the device used, sold by General Plasma Inc., comprised two plasma beam sources connected to an AC power supply in order to produce, in alternation, plasma and ion beams allowing the material comprising silicon, oxygen and carbon to be deposited on the substrate. Each plasma beam source comprised a discharge cavity having a first width and a nozzle that extended toward the exterior from the cavity in order to emit the ion beam. The aperture or outlet of the nozzle had a second width that was smaller than the first width. As shown in FIGS. 12A and 12B of publication U.S. Pat. No. 7,411,352, a plurality of magnets placed generally facing one another were arranged adjacent the discharge cavity in order to create a magnetic-field free region inside the discharge cavity. The AC power supply was connected to electrodes in each discharge cavity and each plasma beam source alternately served as an anode or a cathode. At least one magnetron discharge region serving as a cathode was present inside the discharge cavity. In operation, a dense and uniform plasma beam issued from the cathode source and an ion beam issued from the anode source. The interested reader will especially find all the technical information necessary to understand the operation of such an installation in U.S. Pat. No. 7,411,352, cited by way of reference.

The substrate used in this example was a glass pane sold by the applicant company under the trade name Diamant®. The precursor used was HUMSO (hexamethyl disiloxane). It was introduced in gaseous form level with the substrate between the two plasma sources by means of two aluminum deflectors that directed the flow of the precursor toward each plasmaion beam, at the nozzle outlet.

A HDMSO precursor having a large amount of hydrogen was used in the plasma gas to obtain a hydrogen-containing primary film, i.e. a film of SiOₓC_{y}H_{z}.

The plasma gas used in the present example was a mixture of oxygen and argon in the proportions given in table 1 below, collating the main experimental data from deposition of the film according to the invention. The power delivered by the AC supply, such as shown in table 1, created an electric discharge in each cavity and generated the plasma and ions that allowed the precursor to be broken up and a primary coating comprising atoms of silicon, oxygen, carbon and possibly′hydrogen to be formed on the substrate that was run under the installation.

TABLE 1

| | | |
|---|---|---|
| HDMSO flow rate | 240 | sccm |
| Ar flow rate | 530 | sccm |
| O₂ flow rate | 920 | sccm |
| Power delivered by the AC | 6 | kW |
| supply | | |

The glass substrate equipped with its coating is then subjected to a heat treatment consisting in heating to 640° C. for 8 minutes, followed by a temper. During this step, a nanoporosity is created in the coating via removal of at least some of the carbon (and possibly hydrogen) present in the initially deposited material. This porosity has the effect of reducing the refractive index of the material, thus providing it with the ability to prevent reflection of incident light rays, especially in the wavelength range from 300-2500 nm for photovoltaic applications. This decrease in the refractive index may especially be measured directly via the resulting increase ΔT_{E}, measured as a percentage of the energy transmission coefficient T_{E} of the substrate equipped with the antireflection film, relative to the reference value measured beforehand for the same, but uncoated, substrate.

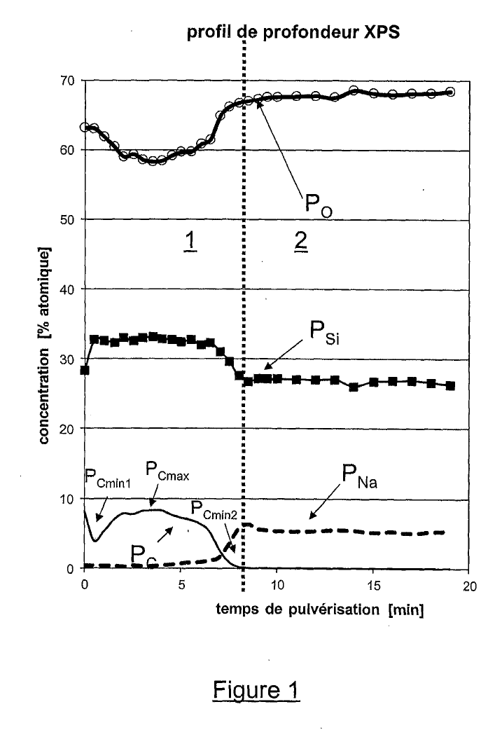

FIG. 1 shows the analysis spectrum of the composition of the coating film, obtained by X-ray photoelectron spectroscopy (XPS). The measurements were carried out with a Quantera SXM® apparatus from Ulvac-PHI using monochromatic K, radiation from aluminum. The concentration profiles in the depth of the film were measured by alternating ion bombardment, to erode the film, and spectral control measurements.

In the graph, the respective concentrations of the various elements contained in the coating film (Y-axis in FIG. 1) are shown as a function of the sputtering time, i.e. as a function of depth in the film (X-axis)—the relative proportions of the elements C, Si and O in said film will be noted.

As may be seen in FIG. 1, the film according to the invention has a carbon concentration profile that had never been observed before: in the prior-art publications, especially in application EP 1 676 291, it is taught that the best performances are expected when the carbon concentration, in the thickness direction of the film, is either substantially constant right through the film, or gradually increases between a minimum value at the “air”-side face to a maximum value at the “substrate”-side face.

In FIG. 1, part 1 on the left-hand side of the dotted vertical line corresponds to the entire thickness of the coating film. Part 2 on the right-hand side of the dotted line corresponds to the composition of the glass substrate, after the film has been completely sputtered away at the point of analysis.

It may be seen in FIG. 1 that the relative proportion of C (curve Pd of the coating according to the invention, in its thickness direction, has an XPS spectroscopy profile that is completely novel, resulting from the specific conditions of the deposition of said film: thus the carbon concentration curve passes, along the thickness axis of the film, through a first minimum (P_{Cmin1}) near a first surface of the film (“air”-side), then through a maximum (P_{Cmax}) and finally through another minimum (P_{Cmin2}) near the opposite surface of the film (the “glass”-side). According to the present invention, the relative proportion of C thus varies between a first minimum, near a first surface of the film, and a second minimum, at a second surface of said film, through a maximum. The inventors attribute the relatively high value of the carbon concentration at the external surface (“air”-side) of the sample according to example 1 to the presence of essentially carbon-based contaminants on the external surface of the coating film.

Trials carried out by the applicant company, such as described in the rest of the description, demonstrated that such a distribution improved the performance of the porous film, not only with regard to the desired optical properties (antireflection effect) but also its chemical and mechanical resistance properties.

The improved properties of the substrates equipped with the coatings thus obtained were measured using the following tests:

A—Optical Properties (Antireflection Effect)

A decrease in reflection from the surface of the glass substrate results in an increase in the energy transmission coefficient T_{E}. As described above, the optical properties of the substrate equipped with the coating were therefore measured by measuring the change ΔT_{E} in the transmission, as a percentage, between the energy transmission of the glass substrate (after tempering) equipped with the multilayer, and the same, but bare, substrate. T_{E} and ΔT_{E} were measured in the 300-2500 nm region of the solar spectrum, according to the criteria defined in ISO standard 9050:2003 (E).

B—Chemical Resistance Test

The resistance of the deposited coatings to abrasion, after tempering, was measured by way of damp heat testing, according to IEC standard 6121510.13, representative of external use of the glazing (climate simulation test): the sample was subjected to extreme damp and temperature conditions (85% relative humidity at 85° C.) for a total time of 2000 h, so as to cause accelerated aging. The, increase ΔT_{E} in the energy transmission described above was measured before testing was started (see A—), then after 2000 h of testing.

C—Mechanical Resistance Test (Abrasion)

The resistance of the deposited coatings to abrasion, after tempering, was measured by the Erichsen test: in this test, which is well known in particular in the field of metallurgy, the resistance of the coating to scratching is measured by bringing the latter into contact with a steel needle that is moved over its surface. The needle is applied with increasing force, from 0.2 newtons to 6 newtons. The mechanical resistance of a coating is, in this way, measured by way of the applied force that causes a scratch.

The results of the various tests A— to C—, for the sample according to example 1, are given in table 2 below.

TABLE 2

| | | B- | C- |
|---|---|---|---|
| | A- | ΔT_{E} after | Maximum Erichsen |
| | ΔT_{E} after | damp heat | test value |
| | tempering | testing | before |
| | (%) | (%) | scratching (N) |
| Example 1 | 2.7 | 2.3 | 0.2 |
| Comparative | 2.2 | 1.3 | 8 |
| example* | | | |

*glazing panel according to EP 1 676 291

As may be seen, a completely satisfactory performance is obtained is obtained for the glazing unit according to the invention, both in terms of optical properties and as regards its mechanical and chemical resistance properties.

The film according to the invention may be used in any type of glazing unit, not just in the field of photovoltaic devices, but also in the architectural field. In particular, in such architectural applications, DGUs (double glazing units) or TGUs (triple glazing units) may be employed in which the porous film according to the invention is combined with a low-E multilayer comprising a functional film made of a precious metal such as silver or gold, the porous film being placed within the multilayer, especially on top, so as to improve performance, especially so as to increase the energy transmission or even the overall solar factor of said glazing unit.

1. A glazing unit comprising a transparent substrate equipped with an antireflection coating, which coating comprises at least one film of a porous material essentially comprising silicon, oxygen, carbon and possibly hydrogen, in which the atomic proportion P_{C} of carbon, relative to the sum of the atomic contributions of silicon, oxygen and carbon, varies locally in the thickness direction of the film, from a first surface to a second surface thereof as follows:
the proportion of carbon increasing between a first minimum value P_{Cmin1} and a maximum value P_{Cmax}, the ratio of said maximum value P_{Cmax} to said first minimum value Pₐₙᵢₙᵢ being at least 1.2; and
the proportion of carbon then decreasing, between said maximum value P_{Cmax} and a second minimum value P_{Cmin2}, the ratio of said maximum value P_{Cmax} to said second minimum value P_{Cmin2} being at least 1.2.

2. The glazing unit as claimed in claim 1, wherein said film has the following general chemical composition, in terms of the respective atomic proportions of just the constituent silicon, oxygen and carbon elements of the composition of the porous material from which said film is made:
between 28 and 38% silicon;
between 55 and 68% oxygen; and
between 2 and 10% carbon.

3. The glazing unit as claimed in claim 1, wherein the antireflection coating consists only of the film of porous material, in which the minimum value P_{Cmin1} of the proportion of carbon in the porous film is reached at the air-side surface of said film or near said surface, and in which the minimum value P_{Cmin2} of the proportion of carbon in the porous film is reached at or near the surface of the substrate.

4. The glazing unit as claimed in claim 1, wherein the respective proportion of silicon in the film is between 30 at % and 35 at %.

5. The glazing unit as claimed in claim 1, wherein the respective proportion of oxygen in the film is between 58 at % and 65 at %.

6. The glazing unit as claimed in claim 1, wherein the respective proportion of carbon in the film is between 3 at % and 8 at %.

7. The glazing unit as claimed in claim 1, wherein the overall amount of carbon in the material of the film is lower than 15 at %.

8. The glazing unit as claimed in claim 1, wherein the ratios P_{Cmax}/P_{Cmin1} and/or P_{Cmax}/P_{Cmin2} are higher than 1.5.

9. The glazing unit as claimed in claim 1, comprising a succession of minimum values P_{Cmin} and maximum values P_{Cmax} of the respective proportion of carbon, in the thickness direction of the film.

10. The glazing unit as claimed in claim 1, wherein the porous film is between 30 and 150 nm in thickness.

11. The glazing unit as claimed in claim 1, wherein the refractive index of the porous film is lower than 1.42.

12. A porous film made of a porous material essentially comprising silicon, oxygen, carbon and possibly hydrogen, in which the atomic proportion P_{C} of carbon, relative to the sum of the atomic contributions of silicon, oxygen and carbon, varies locally in the thickness direction of the film, from a first surface to a second surface thereof as follows:
the proportion of carbon increasing between a first minimum value P_{Cmin1} and a maximum value P_{Cmax}, the ratio of said maximum value P_{Cmax} to said first minimum value P_{Cmin1} being at least 1.2; and
the proportion of carbon then decreasing, between said maximum value Pₘₐₓ and a second minimum value P_{Cmin2}, the ratio of said maximum value Pₘₐₓ to said second minimum value P_{Cmin2} being at least 1.2.

13. The porous film as claimed in claim 12, having the following general chemical composition, in terms of the respective atomic proportions of just the constituent silicon, oxygen and carbon elements of the composition of the porous material from which said film is made:
between 28 and 38% silicon;
between 55 and 68% oxygen; and
between 2 and 10% carbon.

14. A process for manufacturing a glazing unit as claimed in claim 1, comprising:
generating a plasma at the surface of the substrate over its entire width by means of a device comprising at least two plasma beam sources each comprising a cavity in which a discharge is generated, a nozzle that extends toward the exterior, and a plurality of magnets placed facing one another and arranged adjacent the discharge cavity, such that a magnetic-field free region is created inside each discharge cavity, an oxygen-containing ionizable gas being introduced into each discharge cavity and each plasma beam source alternately serving as an anode or a cathode;
running the substrate under the plasma beams;
depositing at least one silicon precursor compound on said substrate between the two plasma sources;
recovering the substrate equipped with a film of a material comprising silicon, oxygen, carbon, and possibly hydrogen; and
subjecting the film thus deposited to a heat treatment under conditions allowing at least part of the carbon to be removed and said film of the porous material to be obtained.

15. The process for manufacturing a transparent substrate as claimed in claim 14, wherein the ionizable gas is a mixture of argon and oxygen the total pressure of the gasses being between 1×10⁻³ and 1×10⁻² mbar.

16. The process for manufacturing a transparent substrate as claimed in claim 14, wherein the one or more silicon precursors are chosen from silicon organometallics, alkylsilanes, silicon alcoholates, or silicon hydrides, or silicon chlorides.

17. The glazing unit as claimed in claim 1, wherein the transparent substrate is a glass substrate.

18. The glazing unit as claimed in claim 7, wherein the overall amount of carbon in the material of the film is lower than 5 at %.

19. The glazing unit as claimed in claim 8, wherein the ratios P_{Cmax}/P_{Cmin1} and/or P_{Cmax}/P_{Cmin2} are higher than 2.

20. The glazing unit as claimed in claim 10, wherein the porous film is between 50 and 120 nm in thickness.

21. The glazing unit as claimed in claim 11, wherein the refractive index of the porous film is lower than 1.35.

22. The process for manufacturing a transparent substrate as claimed in claim 16, wherein the silicon organometallics include siloxanes selected from the group consisting of hexamethyl disiloxane (HMDSO) and tetramethyl disiloxane (TDMSO), wherein the alkylsilanes are selected from the group consisting of diethoxymethylsilane (DEMS), Si(CH₃)₃)₂ (HMDS), Si(CH₃)₄ (TMS), (SiO(CH₃)₂)₄, and (SiH(CH₃)₂)₂, wherein the silicon alcoholates are selected from the group consisting of Si(OC₂H₅)₄ (TEOS) and Si(OCH₃)₄ (TMOS), wherein the silicon hydrides are selected from the group consisting of SiH₄ and Si₂H₆, and wherein the silicon chlorides are selected from the group consisting of SiCl₄, CH₃SiCl₃, and (CH₃)₂SiCl₂.
